(19) United States
(12) Patent Application Publication
(10) Pub. No.: US 2022/0226783 A1
(43) Pub. Date: Jul. 21, 2022

(54) ADDITIVE MANUFACTURING OF SELF-ASSEMBLED POLYMER FILMS

(71) Applicants: Trustees of Tufts College, Medford, MA (US); The University of Connecticut, Farmington, CT (US)

(72) Inventors: Ayse Asatekin Alexiou, Arlington, MA (US); Samuel John Lounder, Medford, MA (US); Jeffrey R. McCutcheon, Tolland, CT (US); Xin Qian, Storrs, CT (US); Tulasi Ravindran, Storrs, CT (US)

(21) Appl. No.: 17/610,020

(22) PCT Filed: May 11, 2020
(86) PCT No.: PCT/US20/32335

§ 371 Date: Nov. 9, 2021

Related U.S. Application Data
(60) Provisional application No. 62/846,019, filed on May 10, 2019.

(51) Int. Cl. B01D 67/00; B33Y 10/00; B33Y 70/00; B33Y 40/20; B29C 64/112; B29C 71/02; B01D 71/76; B01D 69/02; B01D 69/12; B01D 61/14; C08F 218/00; C09D 133/16

(52) U.S. Cl. CPC B01D 67/0002; B33Y 10/00; B33Y 70/00; B33Y 40/20; B29C 64/112; B29C 71/02; B33Y 80/00; B01D 69/02; B01D 69/122; B01D 61/145; C08F 218/20; C09D 133/16; B01D 71/76

(57) ABSTRACT

Disclosed are methods for preparing a thin film composite membrane by subjecting a solution comprising one or more zwitterionic copolymers to an electrospraying process, thereby preparing the thin film composite membrane.

### RELATED APPLICATIONS

This application claims the benefit of U.S. Provisional Application No. 62/846,019, filed May 10, 2019; the contents of which are incorporated herein by reference in their entirety.

### GOVERNMENT SUPPORT

This invention was made with government support under grants 1508049 and 1553661 awarded by the National Science Foundation. The government has certain rights in the invention.

### BACKGROUND

Random copolymers comprising hydrophobic and zwitterionic repeat units have been shown to create membrane selective layers that exhibit several important properties, including exceptional fouling resistance, ˜1 nm effective pore size (corresponding to a molecular weight cut-off, MWCO, of ˜1000 Da coupled with relatively low salt rejection), and high selective layer permeabilities. These properties arise from the fact that the zwitterionic amphiphilic random copolymers self-assemble to create an interconnected network of zwitterionic, water-permeable domains that act as effective membrane pores, and from the exceptional, well-documented fouling resistance of zwitterionic materials.

To date, thin film composite (TFC) membranes that incorporate these zwitterionic amphiphilic random copolymers as their selective layers have been manufactured by first dissolving the copolymer in a solvent (e.g., trifluoroethanol (TFE)), then coating it onto a porous support (typically a commercial membrane with much larger pores) using a doctor blade or coating bar, and finally either evaporating the solvent and/or immersing the coated membrane into a non-solvent (e.g., isopropanol) to quickly precipitate the copolymer. This method, which can be relatively reliably scaled up using roll-to-roll coating systems, typically results in membrane selective layers that are 1-6 μm in thickness. Most commercial TFC membranes, in contrast, have selective layers as thin as 50-200 nm, an order of magnitude thinner than achieved by this method. The thickness of self-assembled zwitterionic amphiphilic copolymer selective layers have been reduced to ˜200 nm in a previous study by adding an ionic liquid additive to the coating solution. However, this approach results in higher loss of the copolymer in the non-solvent bath.

Importantly, none of these approaches are easy to adapt to the formation of multi-layer copolymer films in an easy, scalable manner.

### SUMMARY

Disclosed is a method of printing for hierarchical self-assembled polymers with controllable thickness in manufacturing thin film composite membranes. These membranes exhibit, without a loss of selectivity, permeance that is in excess of 100-fold higher than that of membranes created with conventional methods. Features of this method allow for reassembly of the self-assembled structure during the printing of additional layers and provides interlayer spacing between printed layers that also facilitates transport. The method also enables hierarchical structures to be created (e.g., structural and chemical gradients within the thin films), which can be as little as a few nm in thickness. The method also offers a thin film production approach that is far less wasteful than conventional production methods.

In one aspect, provided are methods of preparing a thin film composite membrane, comprising the steps of:
i) preparing a solution comprising one or more zwitterionic amphiphilic copolymers, wherein each of the zwitterionic amphiphilic copolymers comprises a plurality of hydrophobic repeat units and a plurality of zwitterionic repeat units;
ii) subjecting the solution to an electrospraying process using an electrospray device; and
iii) depositing the zwitterionic amphiphilic copolymers onto a porous substrate to form a selective layer;
   thereby producing the thin film composite membrane.

### BRIEF DESCRIPTION OF THE DRAWINGS

FIG. 1 is a schematic diagram of the electrospray device: zwitterionic copolymer solution and Isopropanol are pumped out at a constant speed onto a rotating drum, where the UF supports are attached. The needle tips are positively charged. The needles are also connected to a moving screw-driven slide that controls the motion of the needles along the rotating drum. The system is enclosed and ventilated for safety.

FIG. 2A are images that depict cross section SEM image of printed TFC membrane with varying scan layers and copolymer solution concentration. Support layer cross section image is taken as control. Selective layer thickness is directly measured on the cross section image. (a) Uncoated support layer. (b-d) TFC membranes printed with 5 scan layers of (b) 0.0625% w/v (c) 0.3% w/v (d) 0.4% w/v copolymer solution. (e-h) TFC membranes printed with 10 scan layers of (e) 0.0625% w/v (f) 0.2% w/v (g) 0.5% w/v (h) 1.0% w/v copolymer solution.

FIG. 2B is an SEM image that shows the surface morphology of the printed TFC membranes with 5 scan layers (unannealed; 6500× magnification).

FIG. 2C is an SEM image that shows the surface morphology of the printed TFC membranes with 5 scan layers (unannealed; 20000× magnification)

FIG. 3A is graph that depicts the relationship between calculated thickness and cross section thickness.

FIG. 3B is a graph that shows the ratio of cross section thickness and calculated thickness at varying selective layer thickness.

FIG. 4A is a plot that compares of water permeance between TFC membranes with various selective layer thickness (both 5 and 10 layers), cast TFC membranes (red dashed line) and commercial PES20 membrane (green dashed line) as well as magnified graph of water permeance change with respect to increasing selective layer thickness. Membranes with the same thickness but different spray layers show similar water permeance.

FIG. 4B is a plot that shows the selective layer water permeability with increasing thickness.

FIG. 5A is a plot that shows Acid Fuchsin rejection of printed TFC membranes with various selective layer thickness (both 5 and 10 layers).

FIG. 5B is a plot that shows Vitamin B12 rejection of printed TFC membranes with various selective layer thickness (both 5 and 10 layers).

FIG. 6 is a graph that depicts dye rejection fluctuation during overnight test for both unannealed (5 and 10 selective layers) and annealed (5 and 10 selective layers). Rejection values in the first 100 min were collected every 25 min, followed by an overnight collection.

FIG. 7 is a bar graph that depicts chlorophyllin rejection of printed TFC membranes with increasing selective layer loading.

FIG. 8 is a plot that compares sized based dye rejection of printed TFC membranes with 5 scans of selective layers (pre and post annealing) and 10 scans of selective layers (pre and post annealing).

FIG. 9A is an image that shows the contact angle for selective layer with 5 scans (unannealed).

FIG. 9B is an image that shows the contact angle for selective layer with 5 scans (annealed).

FIG. 9C is an image that shows the contact angle for selective layer with 10 scans (unannealed).

FIG. 9D is an image that shows the contact angle for selective layer with 10 scans (annealed).

### DETAILED DESCRIPTION

Disclosed is a method of printing for hierarchical self-assembled polymers with controllable thickness in manufacturing thin film composite membranes. These membranes exhibit, without a loss of selectivity, permeance that is in excess of 100-fold higher than that of membranes created with conventional methods.

Compared with the traditional casting method, the disclosed method uses little polymer and has virtually no material waste. This would have value if the coatings contained expensive materials. Additionally, compared with membranes made by hand casting, the method can produce thinner films than conventional casting (by a factor of 100 or more). This leads to higher water permeance without the loss of selectivity.

This method enables the deposition of self-assembled polymers as an ultra-thin layer (<1 um) directly onto a substrate for use as a thin film composite membrane. The thickness can be adjusted by changing polymer concentration or the number of layers of polymer deposited. No other method offers this level of thickness control while also being considered scalable to a roll-to-roll process.

The method could extend to a variety of self-assembled polymer materials that have few options for being formed into thin films (e.g., less than 1 micron in thickness).

The method enables the formation of hierarchical structures, meaning that even in ultra-thin films we can control microstructure (i.e., a 100 nm thick film can have chemical and structural heterogeneity from one side of the film to the other).

The disclosed method enables the electrospray of a single polymer solution, instead of two monomer solutions. It is likewise possible to deposit a blend of miscible polymers, a self-assembled polymer, or a monomer solution including an polymerization initiator that activates upon deposition (e.g., a photoinitiator or a chemical initiator) from a single needle. For example, a polymer film including entrapped nanoparticles could be formed from a single polymer solution containing the nanoparticles.

The tunable thickness control is related to the concentrations of the solutions. Lower solution concentrations are generally expected to allow for finer control of the thickness. The thickness is also determined by the number of layers (i.e. scans) of polymer formed. Similarly, roughness depends primarily on the solution concentration and number of layers. Lower concentrations typically produce smoother films and fewer layers tend to result in smoother films.

The thickness and roughness can be independently controlled. For example, a few layers formed from high concentration monomer solutions can create a thick, rough film, whereas many layers formed from lower concentration monomer solutions can create a film of equal thickness but lower roughness.

In certain embodiments, the number of scans (i.e. layers) is between 1 and 10. In certain embodiments, the number of scans is greater than 1, 2, 3, 4, 5, 6, 7, 8, 9, or 10. In certain embodiments, the number of scans is less than 50, 40, 30, 20, 10, 9, 8, 7, 6, 5, 4, 3, or 2. In certain embodiments, the number of scans is 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, or greater than 100.

Porous substrates useable with the disclosed methods include microfiltration (MF) membranes, such as polymer MF membranes made with polyvinylidene fluoride (PVDF), nylon, polysulfone, polyethersulfone, polyacrylonitrile, polycarbonate, polybenzimidizoles, cellulosic polymeric materials, or combinations thereof. Other suitable porous substrates include, but are not limited to, ultratfiltration (UF) membranes (e.g. polymer membranes, including those made with the polymers listed above), inorganic membranes (e.g. silica based substrates, siloxane based polymers, ceramics, glass, or metal membranes), fibrous membranes (nonwoven or woven membranes of suitable pore and fiber size), or combinations thereof.

In one aspect, provided are methods of preparing a thin film composite membrane, comprising the steps of:
i) preparing a solution comprising one or more zwitterionic amphiphilic copolymers, wherein each of the zwitterionic amphiphilic copolymers comprises a plurality of hydrophobic repeat units and a plurality of zwitterionic repeat units;
ii) subjecting the solution to an electrospraying process using an electrospray device; and
iii) depositing the zwitterionic amphiphilic copolymers onto a porous substrate to form a selective layer;
   thereby producing the thin film composite membrane.

In certain embodiments, the zwitterionic amphiphilic copolymers are statistical copolymers. In certain embodiments, the zwitterionic amphiphilic copolymers are linear copolymers. In certain embodiments, the zwitterionic amphiphilic copolymers are random copolymers. In certain embodiments, the zwitterionic amphiphilic copolymers are linear, random, and statistical copolymers.

In certain embodiments, each of the zwitterionic repeat units independently comprises sulfobetaine, carboxybetaine, or pyridinium alkyl sulfonate.

In certain embodiments, each of the zwitterionic repeat units is independently formed from sulfobetaine acrylate, sulfobetaine acrylamide, carboxybetaine acrylate, carboxybetaine methacrylate, carboxybetaine acrylamide, 3-(2-vinylpyridinium-1-yl)propane-1-sulfonate, 3-(4-vinylpyridinium-1-yl)propane-1-sulfonate, or sulfobetaine methacrylate.

In certain embodiments, each of the hydrophobic repeat units is independently formed from styrene, fluorinated styrene, an alkyl acrylate (e.g., methyl acrylate), an alkyl methacrylate (e.g., methyl methacrylate), acrylonitrile, a fluoroalkyl acrylate, a fluoroaryl acrylate, a fluoroalkyl methacrylate (e.g., trifluoroethyl methacrylate), a fluoroaryl methacrylate, a fluoroalkyl acrylamide, and a fluoroaryl acrylamide.

In certain embodiments, the zwitterionic amphiphilic copolymer is poly((methyl methacrylate)-random-(sulfobetaine methacrylate)), poly((trifluoroethyl methacrylate)-random-(sulfobetaine methacrylate)), poly((acrylonitrile)-random-(sulfobetaine methacrylate)), poly((trifluoroethyl methacrylate)-random-(3-(2-vinylpyridinium-1-yl)propane-1-sulfonate)), or poly((acrylonitrile)-random-(3-(4-vinylpyridinium-1-yl)propane-1-sulfonate)).

In certain embodiments, the zwitterionic amphiphilic copolymer is poly((trifluoroethyl methacrylate)-random-(sulfobetaine methacrylate)).

In certain embodiments, the zwitterionic amphiphilic copolymer has a molecular weight of about 10,000 to about 10,000,000 Dalton.

In certain embodiments, the zwitterionic amphiphilic copolymer has a molecular weight of about 20,000 to about 500,000 Dalton.

In certain embodiments, the zwitterionic repeat units and the hydrophobic repeat units each constitute 25-80% by weight of the zwitterionic amphiphilic copolymer.

In certain embodiments, the zwitterionic repeat units constitute 30-75% by weight of the zwitterionic amphiphilic copolymer, and the hydrophobic repeat units constitute 25-70% by weight of the zwitterionic amphiphilic copolymer.

In certain embodiments, the zwitterionic amphiphilic copolymer is poly((trifluoroethyl methacrylate)-random-(sulfobetaine methacrylate)), the zwitterionic repeat units constitute 20-75% by weight of the zwitterionic amphiphilic copolymer, and the zwitterionic amphiphilic copolymer has a molecular weight of about 20,000 to about 100,000 Dalton.

In certain embodiments, the electrospray device comprises a dual-syringe setup;

wherein one syringe contains the solution comprising one or more zwitterionic amphiphilic copolymers, and the other syringe contains a poor solvent for the one or more zwitterionic amphiphilic copolymers.

In certain embodiments, the poor solvent is an alcohol. In certain embodiments, the poor solvent is isopropanol.

In certain embodiments, the solution comprises a mixed solvent. In certain embodiments, the mixed solvent comprises 2,2,2,-trifluoroethanol and dimethylformamide. In certain embodiments, the 2,2,2,-trifluoroethanol and the dimethylformamide are in about 1:1 v/v ratio.

In certain embodiments, the solution comprising one or more zwitterionic amphiphilic copolymers has a zwitterionic amphiphilic copolymer concentration of about 0.001% w/v to about 1% w/v.

In certain embodiments, a scan of the electrospraying process provides selective layer thickness of about 0.05 um to about 1.5 um; and the scan corresponds to rotating a drum collector by 360 degrees.

In certain embodiments, the selective layer has an average effective pore size of about 0.5 nm to about 1.5 nm. In certain embodiments, the selective layer has an average effective pore size of about 1 nm.

In certain embodiments, the selective layer has a thickness of about 20 nm to about 5 um. In certain embodiments, the selective layer has a thickness of about 100 nm to about 2 um.

In certain embodiments, the selective layer exhibits chlorophyllin rejection of more than >99%.

In certain embodiments, the thin film composite membrane exhibits an average water permeance of about 1 LMH/bar to about 5 LMH/bar. In certain embodiments, the thin film composite membrane exhibits an average water permeance of about 2 LMH/bar to about 3 LMH/bar.

In certain embodiments, the thin film composite membrane is further subject to an annealing process. In certain embodiments, the annealing process increases the average water permeance by about 1-10 LMH/bar. In certain embodiments, the annealing process increases the average water permeance by about 3-6 LMH/bar.

In certain embodiments, steps i) to iii) are repeated one or more times, thereby producing a plurality of selective layers, wherein each of the selective layers comprises a composition that is the same or different to an adjacent selective layer.

Electrospraying

The disclosed methods allows for formation of a very thin, highly selective, and permeable film on the top of a porous supporting substrate. The methods may be easily scalable and may use substantially less chemicals than conventional methods. The methods are also capable of controlling the layer thickness and can greatly reduce membrane surface roughness in comparison to conventional interfacial polymerization. Thinner membranes can offer higher productivity membranes (permeance). Smoother membranes can offer superior fouling resistance for a variety of membrane processes.

The electro-sprayed polymerization methods described herein use an electric field to produce a fine mist of one, two, or more solutions, and deposit the aerosol(s) on a substrate surface. The nanoscale size of the aerosol(s) allows for high surface areas of droplets for reaction or deposition, thereby increasing reaction or self-assembly rates to allow for rapid and defect-free film formation on the substrate. The disclosed process may be tunable with regard to controlling surface roughness and surface thickness. The process may be support-independent (i.e., applicable to many distinct types of supports), and may requires much lower volumes of monomer solutions.

It is possible to electrospray a single polymer solution. It is likewise possible to deposit a single polymer, a blend of miscible polymers, a self-assembled polymer, or a monomer solution including an polymerization initiator that activates upon deposition (e.g. a photoinitiator or a chemical initiator) from a single needle. For example, a polymer film including entrapped nanoparticles could be formed from a single polymer solution containing the nanoparticles.

In certain embodiments, a polymer solution is electrosprayed from one needle, whereas a non-solvent for the polymer that enhances the rate at which it precipitates is sprayed from another needle.

The tunable thickness control is related to the concentrations of the solutions, as shown below. Lower solution concentrations are generally expected to allow for finer control of the thickness. The thickness is also determined by the number of layers (i.e. scans) of polymer formed. Similarly, roughness depends primarily on the solution concentration and number of layers. Lower concentrations typically produce smoother films-perhaps due to a lower heat of reaction causing less wrinkling during film formation- and fewer layers tend to result in smoother films.

The thickness and roughness can be independently controlled. For example, a few layers formed from high concentration monomer solutions can create a thick, rough film, whereas many layers formed from lower concentration monomer solutions can create a film of equal thickness but lower roughness.

In certain embodiments, the number of scans (i.e. layers) is between 1 and 10. In certain embodiments, the number of scans is greater than 1, 2, 3, 4, 5, 6, 7, 8, 9, or 10. In certain embodiments, the number of scans is less than 50, 40, 30, 20, 10, 9, 8, 7, 6, 5, 4, 3, or 2. In certain embodiments, the number of scans is 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, or greater than 100.

In certain embodiments, the composition of the solution being electrosprayed in the first scan is different from the composition of the solution being electrosprayed in a later scan. This creates a variation in the composition and/or morphology of the selective layer being deposited along its thickness. This allows for better control over the performance of the resultant membrane.

In certain embodiments, a thin polymer layer is formed onto a porous substrate using electrospraying. A polymer or a monomer may be ejected from one or more needles that are charged by a high voltage power supply. Droplets of the polymer or monomer emerge from the needle(s) and are propelled toward a collector surface by an electric field. The collector surface may be the porous substrate, or the porous substrate may be wrapped around the collector surface. Additionally, the collector surface may be configured on a rotating cylinder and/or the surface material may comprise a porous material or membrane.

The electrospraying methods form very fine droplets, which increase the overall surface area available for reaction and thereby increase the speed of the polymerization reaction when monomers are deposited. In certain embodiments, the disclosed methods enable uniform layer formation and tight control of the thickness of the polymer layer.

As disclosed herein, electrospray can be used to deposit a polymer, or a monomer that form, a polymer, as nanoscale droplets onto a substrate. During electrospraying, liquid leaves a needle in the presence of a strong electric field. Coulombic repulsion forces the ejected droplets to disburse with diameters well below 1 μm. As disclosed herein, a monomer can be deposited onto a substrate where it can subsequently polymerize in place.

For commercial desalination membranes, typical RMS roughness values are about 80 nm to about 100 nm. For the methods disclosed herein, observed roughness can be lower than the commercial membranes. In certain embodiments, the RMS roughness of the disclosed films may be less than about 80 nm, about 70 nm, about 60 nm, about 50 nm, about 45 nm, about 40 nm, about 35 nm, about 30 nm, about 25 nm, about 20 nm, about 15 nm, about 10 nm, about 10 nm, about 5 nm, about 4 nm, about 3 nm, about 2 nm, or approximately molecularly smooth.

### EXAMPLES

In order that the invention described herein may be more fully understood, the following examples are set forth. The examples described in this application are offered to illustrate the compounds, compositions, materials, device, and methods provided herein and are not to be construed in any way as limiting their scope.

### Example 1: Synthesis of poly((trifluoroethyl methacrylate)-random-(sulfobetaine methacrylate)) (PTFEMA-r-SBMA)

2,2,2-Trifluoroethyl methacrylate (TFEMA, Aldrich) and sulfobetaine methacrylate (SBMA, Aldrich) were passed through a column of basic activated alumina (VWR) to remove inhibitors therein. SBMA (4 g) was dissolved in dimethyl sulfoxide (DMSO, 100 ml) in a round bottom flask while stirring at 350 rpm.

TFEMA (6 g) and azobisisobutyronitrile (AIBN, Aldrich; 0.0125 g) were added into the round bottom flask. TFEMA:SBMA in a ratio of 60:40 wt:wt were added to the flask. The flask was sealed with a rubber septum. Nitrogen was bubbled through the mixture thus prepared for 20 minutes to purge any dissolved oxygen. The flask was then kept at 70° C. while stirring at 350 rpm for at least 48 hours. 0.5 g of 4-methoxyphenol (MEHQ) was added thereafter to terminate the reaction. The reaction mixture was first precipitated in water. The polymer clumped at the bottom of the flask was collected and purified by stirring it in two fresh portions of ethanol/hexane mixture (1:1 v:v) overnight, followed by drying under vacuum overnight. The composition of the white polymer was calculated from a 1H NMR spectrum, using the ratio of the total backbone protons (0.5-2 ppm) to the protons of SBMA (2-3.5 ppm). The copolymer was determined to contain 36 wt % SBMA.

### Example 2: Fabrication of Thin Film Composite Membrane

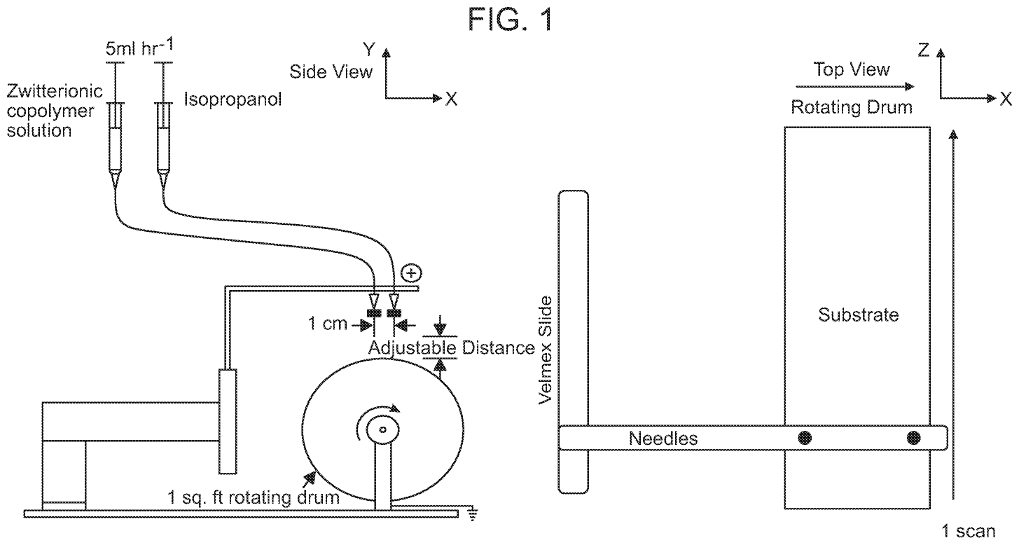

The printing device for fabricating thin films is illustrated in FIG. 1. The zwitterionic amphiphilic copolymer solution and a nonsolvent were sequentially sprayed using positively charged needles held in place holder that is rastered by a screw-driven slide (Velmex), which moves along the drum axial direction. The solutions are comprised of the zwitterionic copolymer PTFEMA-r-SBMA dissolved in mixed solvent (TFE:DMF=1:1 v/v). Polymer solution concentration varies from 0.001% w/v to 1% w/v (Table 2), which was achieved by mixing different amount of copolymer in the mixed solvent. For example, 0.5% w/v solution was made by mixing 0.5 g copolymer with 50 mL/50 mL solvent mixture in a 50° C. water bath for 6 hours. The non-solvent is isopropanol, which is used to precipitate the copolymer from the mixed solvent during electrospray. The copolymer is comprised 36 wt % SBMA, which was shown in previous studies to lead to membranes with good rejection and fouling resistance. Membranes were formed at 23° C. and 16% RH. Membranes were made with 5 or 10 layers of the copolymer being deposited at a flow rate of 3.9 ml/hr. Selective layer thickness was varied by adjusting the polymer solution concentration and the number of layers deposited. The film is formed on an ultrafiltration membrane substrate which is attached to the drum and is used solely as a mechanical support.

### Example 3: Selective Layer Thickness Characterization

Selective coating thickness was varied by adjusting the copolymer solution concentration and the number of layers and was calculated based on material mass balance:

$${δ}_{t h e o r e t i c a l} = \frac{{m}_{polymer}}{{ρ}_{polymeτ} \times A} \qquad ( 1 )$$

$${m}_{polymer} = N \times {V}_{0} \times C \qquad ( 2 )$$

$${ρ}_{polymer} = \frac{{ρ}_{P T F E M A} \times {ρ}_{P S B M A}}{{ρ}_{P T F E M A} \times {ω}_{P S B M A} + {ρ}_{P S B M A} \times {ω}_{P T F E M A}} \qquad ( 3 )$$

Where A is the spray area (cm²), N is the scan layer number, Vo is the volume of the polymer solution ejected per scan layer and C is the polymer solution concentration (w/v). The thickness of the selective layers with all scan numbers and copolymer solution concentrations is presented in Table 2.

TABLE 2
Zwitterionic amphiphilic copolymer solution with different
concentration and their calculated thicknesses (Unit: nm).

| | 5 Layers (nm) | 10 Layers (nm) |
|---|---|---|
| Pristine Support | 0 | 0 |

| | | | |
|---|---|---|---|
| 0.001% | w/v | 0.36 | 0.73 |
| 0.01% | w/v | 3.64 | 7.28 |
| 0.0625% | w/v | 22.73 | 45.46 |
| 0.2% | w/v | 72.73 | 145.47 |
| 0.3% | w/v | 109.1 | 218.2 |
| 0.4% | w/v | 145.47 | 290.94 |
| 0.5% | w/v | 181.83 | 363.67 |
| 1.0% | w/v | 363.67 | 727.34 |

*these thicknesses were extrapolated from the calibration curve in FIG. 3

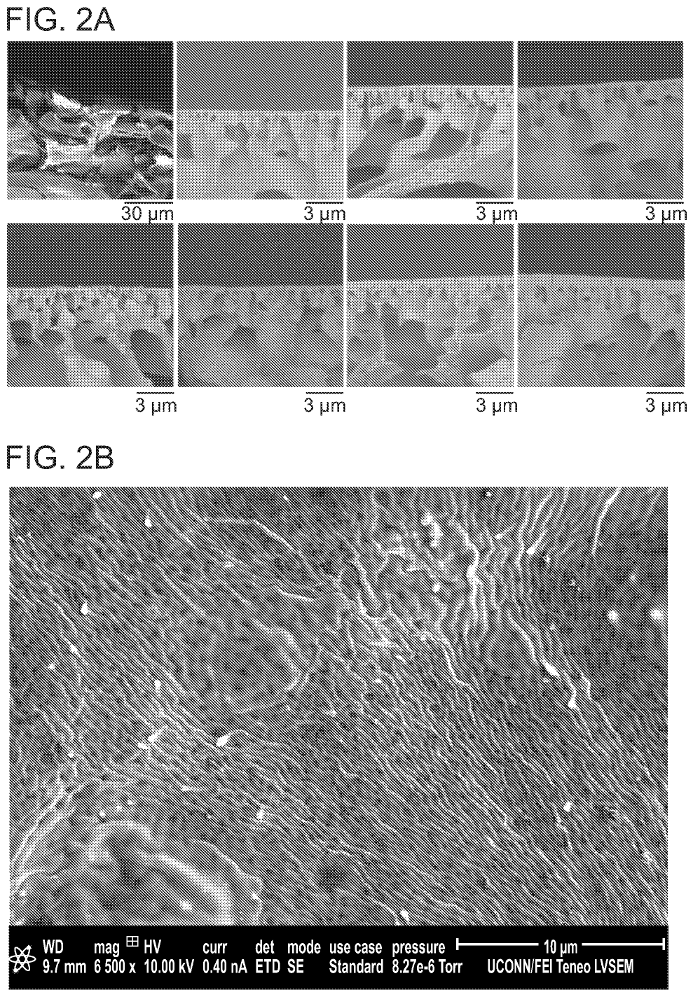

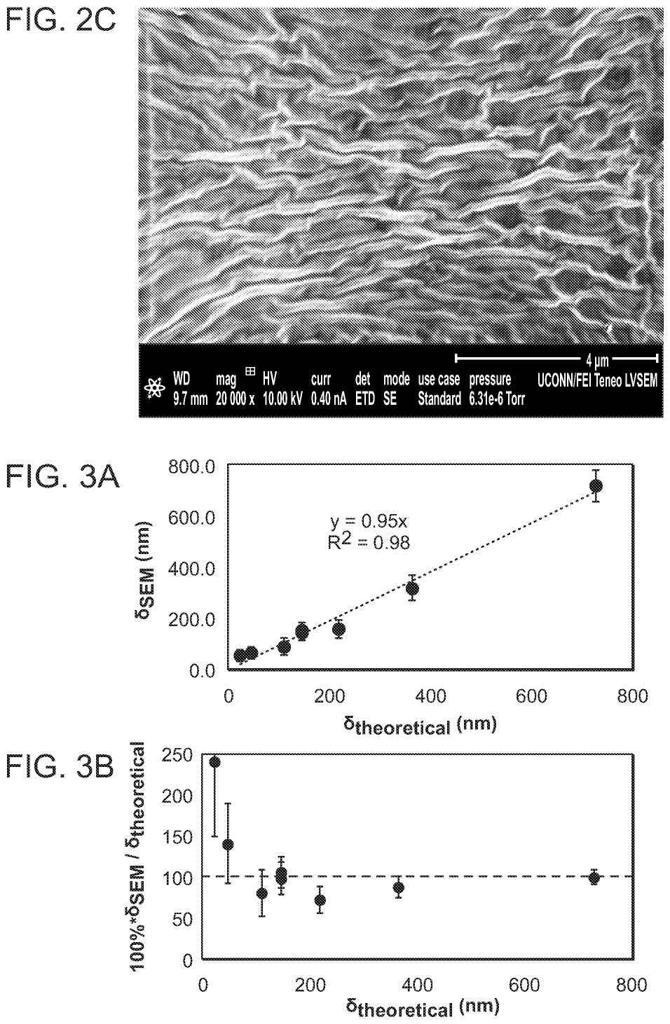

Cross section SEM images (FIG. 2A) of the TFC membranes also reveal the thickness of the selective layer, which can be directly compared with the calculated thickness. A parity plot showing the calculated thickness and cross section thickness (FIGS. 3A and 3B) indicated a slope of ˜1, which suggests that this method of “calibrating” thickness to be appropriate. Table 2 shows the calculated data of the thickness across the membranes that were made. It is noted that the very thin membranes had thicknesses that were extrapolated from the calibration curve in FIG. 3A. These thicknesses also do not account for the potential of absorption of polymer into the pores, which is more likely to happen with lower concentration polymers. The ratio of cross section thickness and calculated thickness at varying thicknesses (FIG. 3B) shows that for membranes thinner than 100 nm these two thicknesses are no longer consistent. SEM images also show that selective layers formed by 0.0625% w/v solution are indistinguishable from the skin layer of the support. Therefore, thickness measurement at low thickness is rather difficult for current techniques due to the possibility of the penetration of polymers into the pores that induces the difficulty to distinguish the selective layer from the support skin layer.

### Example 3: Water Permeance Study

### 3.1. Water Permeance

Permeability is defined as thickness normalized permeance and can be calculated using equation (4), where selective layer permeability is the division of thickness by its resistance:

$$P = A δ = \frac{δ}{{R}_{s e l e c t i v e}} \qquad ( 4 )$$

Where A is the water permeance (LMH/bar), δ is the selective layer thickness (μm), and R_{selective} is the resistance of the selective layer (bar m² hr L⁻¹).

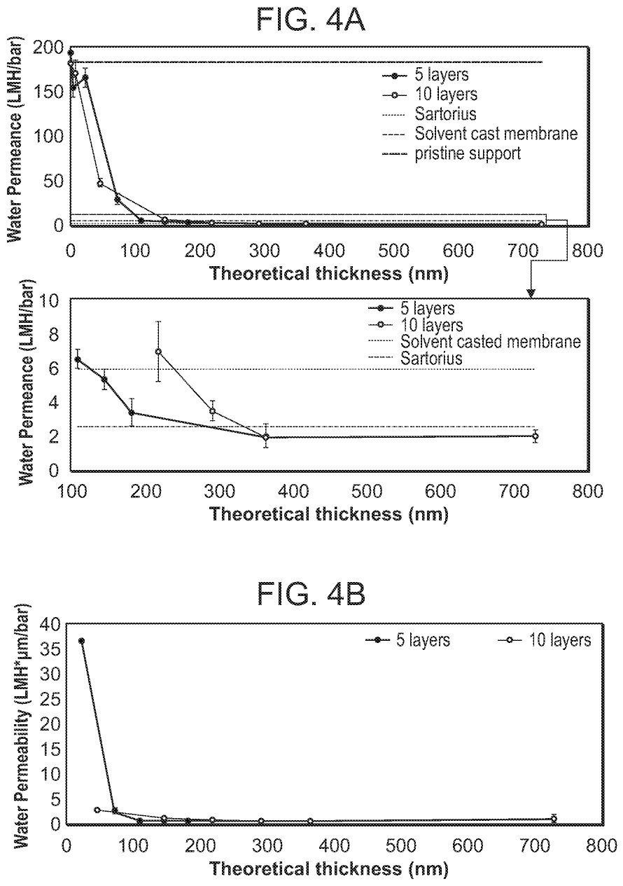

FIG. 4A and FIG. 4B show water permeance values of the 5 and 10 layered membranes with increasing selective layer thickness. Since water permeance is inversely proportional to selective layer thickness, it is observed that a decrease of permeance with increasing membrane thickness. the 0-10 LMH/bar region of FIG. 4A and FIG. 4B is magnified to improve fidelity of the data for analysis. Interestingly, it is observed that similar water permeance values between membranes with the same selective layer thickness achieved by varying scan layers and solute concentration. For example, the membrane produced with 5 layers of a 1.0% w/v polymer solution had a calculated thicknesses of 364 nm and exhibited a permeance of 2.0 LMH/bar. A membrane made with 10 layers of a 0.5% w/v polymer solution also had the same thickness and had a measured permeance of 1.9 LMH/bar. In addition, much higher water permeance values were observed for membranes with thin selective layer. It is hypothesized that there is air trapped between each two layers that provides highways for water transport. As a result, it can be easy for water to pass through thinner individual layers since they have low resistance and the highways between layers won't inhibit the flow. Therefore, membrane permeance mainly depends on the total resistance of the selective layer rather than the number of scans. Interestingly, membranes carrying ultra-thin selective layer (5 or 10 layers of 0.001% w/v copolymer solution) exhibit no discernable difference in water permeance compared with pristine support layer. Solvent cast membranes from the same material exhibited a permeance value of 5.9 LMH/bar. Commercial membranes (Sartorius, PES20) with similar pore size were also tested for comparison and they displayed a much lower permeance value of 2.55 LMH/bar.

### Example 4: Dye Rejection Study

### 4.1. Acid Fuchsin and Vitamin B12 Rejection of TFC Membranes

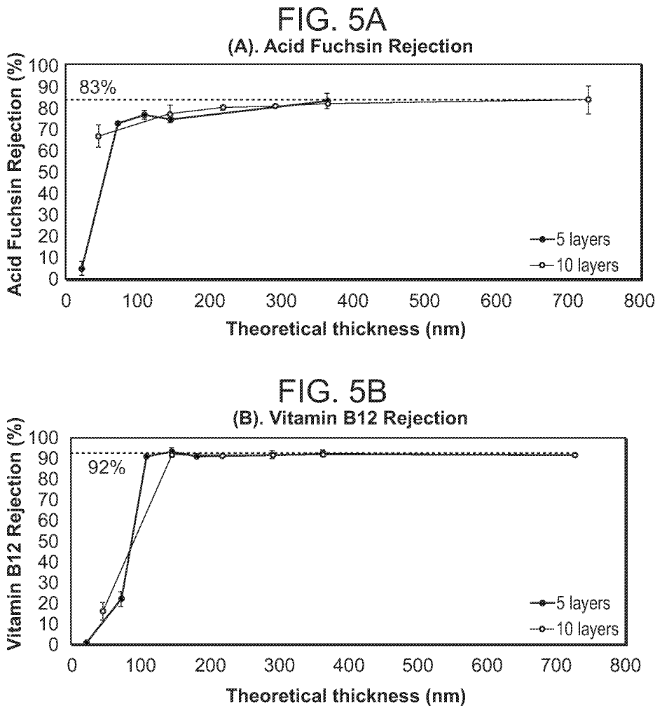

Based on previous report on the water channel size of cast membranes, two dyes—Acid Fuchisin (−1 charge and molecular diameter closed to cutoff size) and Vitamin B12 (neutral charge and molecular diameter larger than cutoff size) were used to characterize the rejection of TFC membranes with all selective layer thickness. FIG. 5A and FIG. 5B show both dyes rejection values collected overnight (at least 22 hrs after the test was started). With thicker selective layer, membranes exhibit a similar trend on the rejection values of both dyes that they increase drastically at low selective layer thickness followed by a stabilized plateau after 100 nm selective layer was formed, which agrees with the threshold thickness for forming constant water permeability. Therefore, at least 100 nm copolymer coating is required to generate functional selective layer.

### 4.2. Influence of Dye Size and Charge on Membrane Rejection

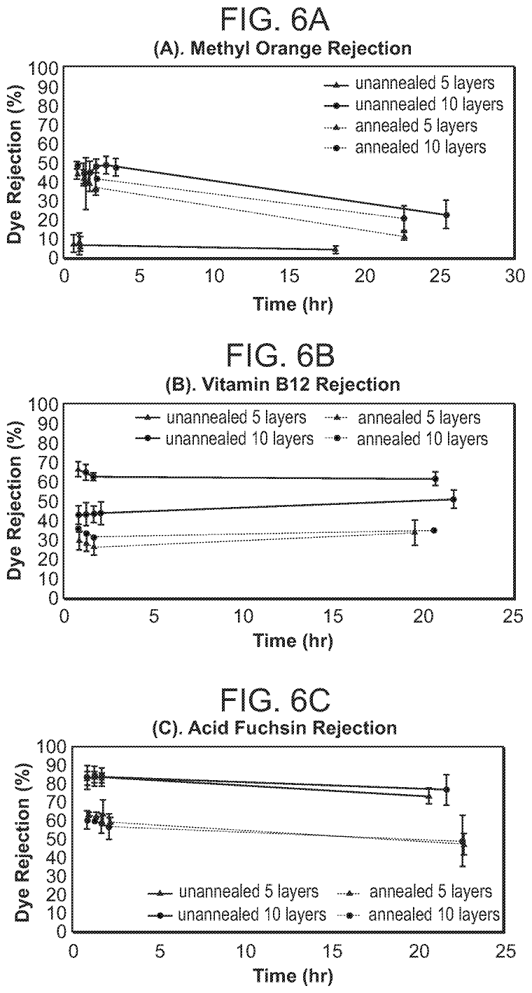

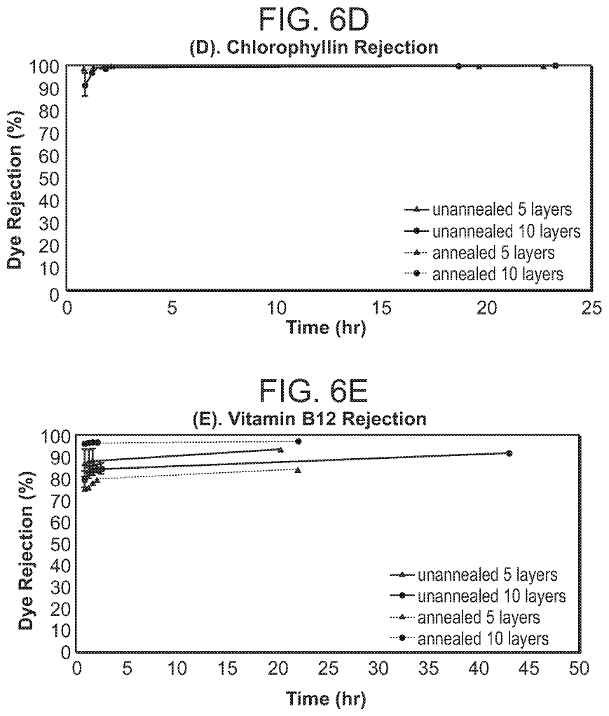

Dye rejection tests were conducted overnight to characterize the membrane long-term rejection stability. FIG. 6 reports the dye selectivity equilibration of membranes (both pre and post annealed) electrosprayed by 5 and 10 scan layers of 1% w/v copolymer solution. Dye selectivity remained stable during overnight tests although some membranes exhibited some ripening (dye rejection increase after long time filtration). Ripening was more likely with larger dyes (e.g. Chlorophyllin and Vitamin B12) as they tend to accumulate on membrane surface rather than going through the membrane layers after long filtration times. Additionally, much higher rejection value was observed for highly charged dye (Chlorophyllin) than neutral dyes (Vitamin B12). This is due to the repelling interaction between the Chlorophyllin molecules near the membrane surface area and those in the feed solution, which can greatly improve the long-term rejection value.

4.3. Chlorophyllin Rejection of Membranes with Ultra-Thin Selective Layer

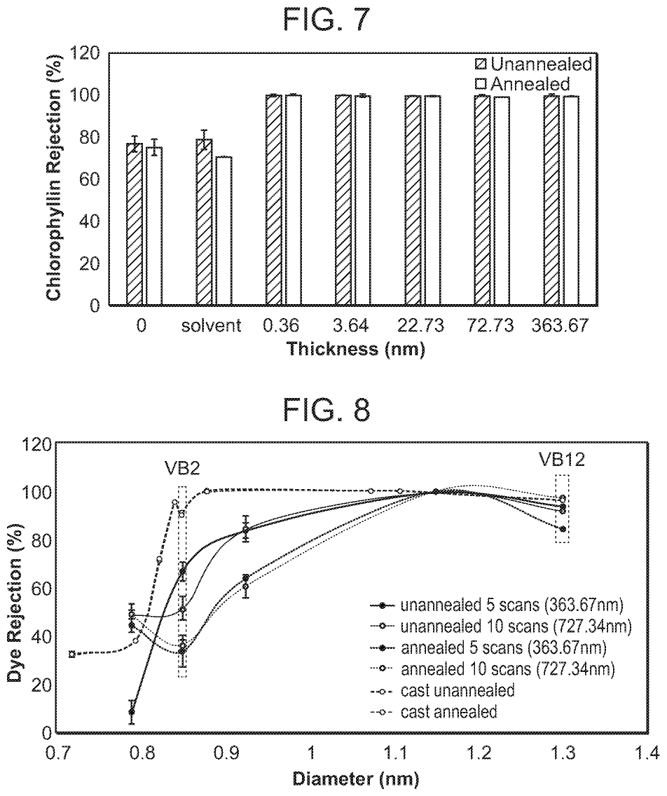

FIG. 7 shows the chlorophyllin rejection of membranes with increasing selective layer thickness. It is indicated in the graph that all membranes with zwitterionic copolymer selective layer regardless of its thickness exhibit a nearly 100% chlorophyllin rejection. The rejection for membranes sprayed with 5 layers of pure solvent was also tested and found similar rejection value to pristine support. This result indicates that solvent is not able to accumulate and close the pores on the PAN400 support surface, which was originally hypothesized as a potential cause to the high rejection of the ultra-thin selective layer. Therefore, membranes with ultra-thin selective layer (0.36 nm and 3.64 nm) are both highly permeable (permeance close to pristine support) and selective (100% chlorophyllin rejection).

### 4.4. Membrane Rejection Curve

In order to evaluate the membrane separation mechanism, the rejection of all the selected dyes on membranes with 5 and 10 layers zwitterionic copolymer (1% w/v solution used for electrospray) was tested. According to FIG. 8, it indicates a sharp size based rejection of the unannealed membranes with cutoff around 0.95-1.05 nm, which agrees with the size cutoff of the cast TFC membranes reported by previous literature. For neutral dyes such as Vitamin B2 and Vitamin B12, we observed that all membranes, including cast and printed membranes showed a slightly lower rejection for these neutral dyes than charged smaller dye. This is an indication of the impact of dye charge on membrane rejection but overall both cast and printed membranes still display sharp size-based rejection. Compared with cast membranes, the printed membranes exhibit much higher permeance while still maintaining 1 nm size cutoff.

### Example 5: Thin Film Composite Membrane Annealing

Early work showed that these membranes exhibited a water permeance (equal to the water flux divided by the pressure) that was in the same ballpark as those membranes by phase inversion casting, typically between 1.5-6 L/m²·h·bar. Annealing, which is a process where the film is heated at a specific temperature for a specific amount of time, was found to increase the permeance by a factor of up to 5.

Annealed membranes were found to show lower dye rejection than unannealed membranes for dyes that are smaller than the estimated cutoff (1 nm). It is reported that annealing is able to narrow the pore size distribution of membranes. Therefore, after annealing the size of most zwitterionic nanochannels is close to the cutoff, which reduces the rejection of smaller dyes. For larger dyes, since their size is larger than the cutoff, no obvious change in their rejection values after annealing was observed.

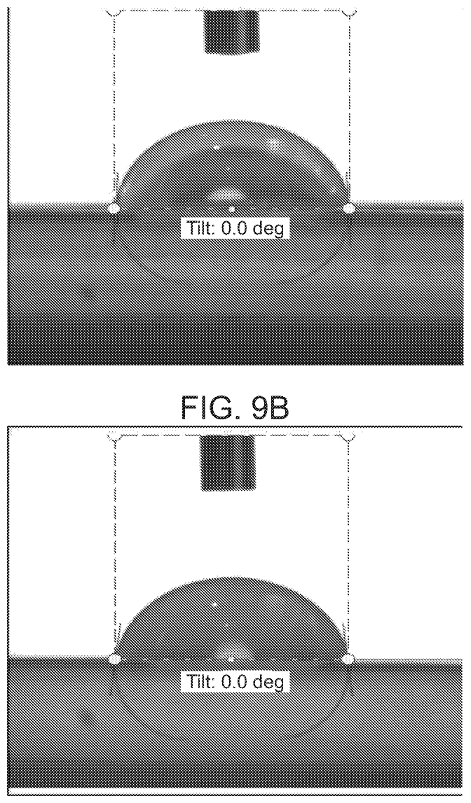

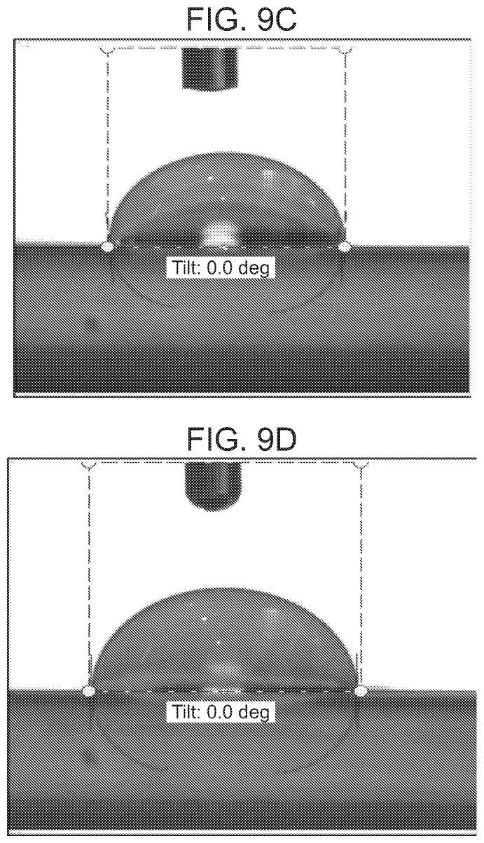

FIG. 9 shows the contact angle (surface hydrophilicity) before and after annealing process. The contact angle for selective layer with 5 scans before annealing: 88.44±0.90; after annealing: 83.74±0.24; 10 scans before annealing: 93.96±3.03; after annealing 10 scans: 88.56±0.96.

### REFERENCES CITED

1. Bengani, P.; Kou, Y.; Asatekin, A. (Jul. 20, 2015). “Zwitterionic Copolymer Self-Assembly for Fouling Resistant, High Flux Membranes with Size-Based Small Molecule Selectivity”. Journal of Membrane Science 493(2015)755-765.
2. P. Bengani-Lutz, E. Converse, P. Cebe, A. Asatekin, Self-assembling zwitterionic copolymers as membrane selective layers with excellent fouling resistance: Effect of zwitterion chemistry, ACS Applied Materials and Interfaces, 9 (2017) 20859-20872.
3. P. Bengani-Lutz, R. Zaf, P. Z. Culfaz Emecen, A. Asatekin, Extremely fouling resistant zwitterionic copolymer membranes with ˜1 nm pore size for treating municipal, oily and textile wastewater streams, Journal of Membrane Science, 543 (2017) 184-194.
4. A. Asatekin Alexiou, P. Bengani, Zwitterion Containing Membranes, U.S. Pat. No. 10,150,088, issued Dec. 11, 2018.
5. P. Bengani-Lutz, A. Asatekin Alexiou, Fabrication of Filtration Membranes, U.S. Patent application No. 62/416,340, filed Nov. 2, 2016.
6. Chowdhury et al., “3D printed polyamide membranes for desalination”. Science 361, 682-686 (2018) 17 Aug. 2018.
7. Ma, X.; Yang, Z.; Yao, Z.; Guo, H.; Xu, Z.; Tang, Y. C. “Interfacial Polymerization with Electrosprayed Microdroplets: Toward Controllable and Ultrathin Polyamide Membranes”. Environmental Science & Technology Letters 2018 5 (2), 117-122.

We claim:

1. A method of preparing a thin film composite membrane, comprising the steps of:
i) preparing a solution comprising one or more zwitterionic amphiphilic copolymers, wherein each of the zwitterionic amphiphilic copolymers comprises a plurality of hydrophobic repeat units and a plurality of zwitterionic repeat units;
ii) subjecting the solution to an electrospraying process using an electrospray device; and
iii) depositing the zwitterionic amphiphilic copolymers onto a porous substrate to form a selective layer;
thereby producing the thin film composite membrane.

2. The method of claim 1, wherein each of the zwitterionic repeat units independently comprises sulfobetaine, carboxybetaine, or pyridinium alkyl sulfonate.

3. The method of claim 2, wherein each of the zwitterionic repeat units is independently formed from sulfobetaine acrylate, sulfobetaine acrylamide, carboxybetaine acrylate, carboxybetaine methacrylate, carboxybetaine acrylamide, 3-(2-vinylpyridinium-1-yl)propane-1-sulfonate, 3-(4-vinylpyridinium-1-yl)propane-1-sulfonate, or sulfobetaine methacrylate.

4. The method of any one of claims 1-3, wherein each of the hydrophobic repeat units is independently formed from styrene, fluorinated styrene, an alkyl acrylate (e.g., methyl acrylate), an alkyl methacrylate (e.g., methyl methacrylate), acrylonitrile, a fluoroalkyl acrylate, a fluoroaryl acrylate, a fluoroalkyl methacrylate (e.g., trifluoroethyl methacrylate), a fluoroaryl methacrylate, a fluoroalkyl acrylamide, and a fluoroaryl acrylamide.

5. The method of any one of claims 1-4, wherein the zwitterionic amphiphilic copolymer is poly((methyl methacrylate)-random-(sulfobetaine methacrylate)), poly((trifluoroethyl methacrylate)-random-(sulfobetaine methacrylate)), poly((acrylonitrile)-random-(sulfobetaine methacrylate)), poly((trifluoroethyl methacrylate)-random-(3-(2-vinylpyridinium-1-yl)propane-1-sulfonate)), or poly((acrylonitrile)-random-(3-(4-vinylpyridinium-1-yl)propane-1-sulfonate)).

6. The method of claim 5, wherein the zwitterionic amphiphilic copolymer is poly((trifluoroethyl methacrylate)-random-(sulfobetaine methacrylate)).

7. The method of any one of claims 1-6, wherein the zwitterionic amphiphilic copolymer has a molecular weight of about 10,000 to about 10,000,000 Dalton.

8. The method of claim 7, wherein the zwitterionic amphiphilic copolymer has a molecular weight of about 20,000 to about 500,000 Dalton.

9. The method of any one of claims 1-8, wherein the zwitterionic repeat units and the hydrophobic repeat units each constitute 25-80% by weight of the zwitterionic amphiphilic copolymer.

10. The method of claim 9, wherein the zwitterionic repeat units constitute 30-75% by weight of the zwitterionic amphiphilic copolymer, and the hydrophobic repeat units constitute 25-70% by weight of the zwitterionic amphiphilic copolymer.

11. The method of claim 1, wherein the zwitterionic amphiphilic copolymer is poly((trifluoroethyl methacrylate)-random-(sulfobetaine methacrylate)), the zwitterionic repeat units constitute 20-75% by weight of the zwitterionic amphiphilic copolymer, and the zwitterionic amphiphilic copolymer has a molecular weight of about 20,000 to about 100,000 Dalton.

12. The method of any one of claims 1-11, wherein the electrospray device comprises a dual-syringe setup; wherein one syringe contains the solution comprising one or more zwitterionic amphiphilic copolymers, and the other syringe contains a poor solvent for the one or more zwitterionic amphiphilic copolymers.

13. The method of claim 12, wherein the poor solvent is an alcohol.

14. The method of claim 12, wherein the poor solvent is isopropanol.

15. The method of any one of claims 12-14, wherein the solution comprises a mixed solvent.

16. The method of claim 15, wherein the mixed solvent comprises 2,2,2,-trifluoroethanol and dimethylformamide.

17. The method of claim 16, wherein the 2,2,2,-trifluoroethanol and the dimethylformamide are in about 1:1 v/v ratio.

18. The method of any one of claims 12-17, wherein the solution comprising one or more zwitterionic amphiphilic copolymers has a zwitterionic amphiphilic copolymer concentration of about 0.001% w/v to about 1% w/v.

19. The method of any one of claims 12-18, wherein a scan of the electrospraying process provides selective layer thickness of about 0.05 um to about 1.5 um; and the scan corresponds to rotating a drum collector by 360 degrees.

20. The method of any one of claims 1-19, wherein the selective layer has an average effective pore size of about 0.5 nm to about 1.5 nm.

21. The method of claim 20, wherein the selective layer has an average effective pore size of about 1 nm.

22. The method of any one of claims 1-21, wherein the selective layer has a thickness of about 20 nm to about 5 um.

23. The method of claim 22, wherein the selective layer has a thickness of about 100 nm to about 2 um.

24. The method of any one of claims 1-23, wherein the selective layer exhibits chlorophyllin rejection of more than >99%.

25. The method of any one of claims 1-24, wherein the thin film composite membrane exhibits an average water permeance of about 1 LMH/bar to about 5 LMH/bar.

26. The method of claim 25, wherein the thin film composite membrane exhibits an average water permeance of about 2 LMH/bar to about 3 LMH/bar.

27. The method of any one of claims 1-26, wherein the thin film composite membrane is further subject to an annealing process.

28. The method of claim 27, wherein the annealing process increases the average water permeance by about 1-10 LMH/bar.

29. The method of claim 28, wherein the annealing process increases the average water permeance by about 3-6 LMH/bar.

30. The method of any one of claims 1-29, wherein steps i) to iii) are repeated one or more times, thereby producing a plurality of selective layers, wherein each of the selective layers comprises a composition that is the same or different to an adjacent selective layer.
